(19) United States
(12) Patent Application Publication
(10) Pub. No.: US 2020/0082496 A1
(43) Pub. Date: Mar. 12, 2020

(54) METHOD AND SYSTEM FOR REPRODUCING VISUAL CONTENT

(71) Applicant: CANON KABUSHIKI KAISHA, Tokyo (JP)

(72) Inventors: Eric Wai Shing Chong, Carlingford (AU); Rajanish Ananda Rao Calisa, Artarmon (AU)

(21) Appl. No.: 16/442,330

(22) Filed: Jun. 14, 2019

(30) Foreign Application Priority Data
Aug. 24, 2018 (AU) 2018220142

(51) Int. Cl. G06T 3/00; G06T 7/70; H04N 9/31

(52) U.S. Cl. CPC G06T 3/005; G06T 3/0012; G06T 7/70; G06T 7/60; H04N 9/3147; H04N 9/3191; H04N 9/3185

(57) ABSTRACT

A method of generating an improved warp map for a projection on a non-planar surface. An initial warp map of the projection on the non-planar surface captured by a camera is received, the projection being formed on the non-planar surface using a projector and the initial warp map. A plurality of regions on the non-planar surface is generated, each of the plurality of regions having a size and location determined from a measure of flatness for the region based on the initial warp map. An unwarped image of a calibration pattern projected on the non-planar surface is determined by applying an inverse transform to each of the plurality of regions on the non-planar surface, each transform mapping pixels of the projection to pixels of the camera according to the initial warp map. A plurality of locations in the determined unwarped image of the calibration pattern is determined to generate the improved warp map.

### CROSS-REFERENCE TO RELATED APPLICATIONS

This application claims the benefit of Australian Patent Application No. 2018220142, filed Aug. 24, 2018, which is hereby incorporated by reference herein in its entirety.

### TECHNICAL FIELD

The present invention relates generally to the field of reproducing visual content and, in particular, to a method, apparatus and system for generating a warp map for a projection on a non-planar surface. The present invention also relates to a computer program product including a computer readable medium having recorded thereon a computer program for generating a warp map for a projection on a non-planar surface.

### BACKGROUND

Projectors are widely-used display devices that can be used to reproduce visual content such as an image, text and the like on many surface types. Multiple projectors are commonly used to increase the size of a projection on a projection surface whilst retaining high resolution and brightness. For example, four projectors can be arranged in a grid configuration to reproduce a single image that is four times larger than the image reproduced by a single projector.

One problem of such multi-projector systems is difficulty of aligning projected content on a projection surface. It is important that a viewer perceives a single image that has no visible seams or brightness fluctuations. Precise alignment of the projected content is therefore important.

Many multi-projection systems require a significant amount of manual effort to perform alignment. Some multi-projection systems perform an automatic alignment procedure at system installation time, for example, using projected calibration patterns or structured light patterns. A calibration pattern is a projected pattern of intensity values that, in combination with other calibration patterns, encodes positions within the projected image. However, multi-projector systems may fall out of alignment over time, for example, due to physical movement of a projector or surface, building vibration, or heat fluctuations causing small movement of internal components of a projector. When such multi-projection systems become misaligned, the manual or automatic alignment procedure typically needs to be re-run.

A calibration pattern or structured light pattern typically “encodes” positions in the projector image panel. At a position in a captured image, the structured light pattern can be “decoded”, to identify the corresponding encoded position in the projected image. The decoding process is typically repeated at several positions in the captured image, thereby forming several correspondences (often known collectively as a warp map) between points in the camera image and points in the projector image. Once the camera and projector correspondences are known, the projected images can be aligned.

Many forms of projected calibration patterns or structured light patterns are known. Structured light patterns can be placed in one of two broad categories: temporal patterns and spatial patterns. Spatial calibration patterns typically encode projector position in a spatial region of the projected image. Typically, only a small number of projected images is required, making spatial patterns applicable to dynamic scenes (e.g. when a projection surface is moving). Several spatial calibration patterns consist of a grid of lines or squares. To decode the spatial calibration patterns, the encoding elements (e.g. lines, squares, edges) need to be extracted from the captured image, and be used to re-construct the projected grid. Such methods have a disadvantage of allowing correspondences to be formed at discrete locations only, where the discrete locations correspond to the positions of the projected lines or squares. Forming discrete locations in such a manner limits the number of correspondences and spatial resolution of correspondences.

Other spatial calibration patterns consist of pseudo-random dot patterns. Pseudo-random dot patterns typically guarantee that a spatial window within the projected pattern is unique. Typically, a spatial region of the captured image is extracted, and is correlated with the projected calibration pattern. The position that has the highest correlation is identified as being the projector position that corresponds with the captured image position. Other pseudo-random dot patterns are created by tiling two or more tiles with different sizes throughout the projected image. Each tile contains a fixed set of pseudo-random dots. A position with a captured image is decoded by correlating a region of the captured image with each of the tiles. Based on the positions of the highest correlations, the absolute position in the projected image can be determined.

Spatial calibration patterns consisting of pseudo-random dot patterns allow a dense and continuous set of correspondences to be formed. Spatial calibration patterns consisting of pseudo-random dot patterns use simple and fast correlation techniques (e.g. based on the Discrete Fourier Transform). Further, spatial calibration patterns consisting of a sparse set of pseudo-random dots may be imperceptibly embedded within a projected image. However, correlation techniques typically require the captured calibration pattern to have a minimal amount of warping, in comparison with the projected calibration pattern. Some existing methods ensure that the captured image is not significantly warped, by placing the camera at a known, fixed and small distance from the projector. Methods requiring placement of the camera at a known fixed distance from the projector cannot easily be used in a multi-projector environment, where the projectors (and therefore the cameras) can be moved to a variety of disparate locations. Other existing methods project line patterns in addition to the pseudo-random dot pattern. The line patterns are used to determine the un-warping required to decode the pseudo-random dot pattern. However, the addition of a line pattern increases the visibility of the calibration pattern, which is undesirable in a projection environment.

There is a need to address one or more of the disadvantages of the methods described above.

### SUMMARY

It is an object of the present invention to substantially overcome, or at least ameliorate, one or more disadvantages of existing arrangements.

According to one aspect of the present disclosure, there is provided a method of generating an improved warp map for a projection on a non-planar surface, the method comprising:

receiving an initial warp map of the projection on the non-planar surface captured by a camera, the projection being formed on the non-planar surface using a projector and the initial warp map;

generating a plurality of regions on the non-planar surface, each of the plurality of regions having a size and location determined from a measure of flatness for the region based on the initial warp map;

determining an unwarped image of a calibration pattern projected on the non-planar surface by applying an inverse transform to each of the plurality of regions on the non-planar surface, each transform mapping pixels of the projection to pixels of the camera according to the initial warp map; and

determining a plurality of locations in the determined unwarped image of the calibration pattern to generate the improved warp map.

According to another aspect of the present disclosure, there is provided a system for generating an improved warp map for a projection on a non-planar surface, the system comprising:

a memory for storing data and a computer program;

a processor coupled to the memory for executing the computer program, the program having instructions for:
receiving an initial warp map of the projection on the non-planar surface captured by a camera, the projection being formed on the non-planar surface using a projector and the initial warp map;
generating a plurality of regions on the non-planar surface, each of the plurality of regions having a size and location determined from a measure of flatness for the region based on the initial warp map;
determining an unwarped image of a calibration pattern projected on the non-planar surface by applying an inverse transform to each of the plurality of regions on the non-planar surface, each transform mapping pixels of the projection to pixels of the camera according to the initial warp map; and
determining a plurality of locations in the determined unwarped image of the calibration pattern to generate the improved warp map.

According to still another aspect of the present disclosure, there is provided an apparatus for generating an improved warp map for a projection on a non-planar surface, the apparatus comprising:

means for receiving an initial warp map of the projection on the non-planar surface captured by a camera, the projection being formed on the non-planar surface using a projector and the initial warp map;

means for generating a plurality of regions on the non-planar surface, each of the plurality of regions having a size and location determined from a measure of flatness for the region based on the initial warp map;

means for determining an unwarped image of a calibration pattern projected on the non-planar surface by applying an inverse transform to each of the plurality of regions on the non-planar surface, each transform mapping pixels of the projection to pixels of the camera according to the initial warp map; and

means for determining a plurality of locations in the determined unwarped image of the calibration pattern to generate the improved warp map.

According to still another aspect of the present disclosure, there is provided a non-transitory computer readable medium having a program stored on the medium for generating an improved warp map for a projection on a non-planar surface, the program comprising:

code for receiving an initial warp map of the projection on the non-planar surface captured by a camera, the projection being formed on the non-planar surface using a projector and the initial warp map;

code for generating a plurality of regions on the non-planar surface, each of the plurality of regions having a size and location determined from a measure of flatness for the region based on the initial warp map;

code for determining an unwarped image of a calibration pattern projected on the non-planar surface by applying an inverse transform to each of the plurality of regions on the non-planar surface, each transform mapping pixels of the projection to pixels of the camera according to the initial warp map; and

code for determining a plurality of locations in the determined unwarped image of the calibration pattern to generate the improved warp map.

Other aspects are also disclosed.

### BRIEF DESCRIPTION OF THE DRAWINGS

One or more embodiments of the invention will now be described with reference to the following drawings, in which:

FIG. 1 shows a system for reproducing visual content;

FIGS. 2A and 2B respectively depict a basic curved surface with a single trough and a complex curved surface with multiple peaks and troughs;

FIG. 3 is a schematic flow diagram of a method of rendering one or more projector images;

FIGS. 4A and 4B respectively show a structured light pattern and a captured image of the same pattern projected by a projector;

FIG. 5 is a schematic flow diagram showing a method of determining point correspondences between a projector and camera image planes as used in the method of FIG. 3;

FIG. 6A shows an example of local homography regions in a projector image plane;

FIG. 6B shows an example of local homography regions in a camera image plane;

FIG. 7A shows a forward mapping that allows each camera sample inside a captured calibration pattern to be mapped to a corresponding calibration pattern coordinate;

FIG. 7B shows an inverse mapping that allows a neighbourhood of camera pixels centered at a camera sample to be extracted and unwarped to a patch (or tile) in calibration pattern space with the same dimension as a reference calibration patch;

FIG. 8 is a schematic flow diagram showing a method of determining a local homography transform (LHT) between a projector image plane and camera image plane, as used in the method of FIG. 5;

FIG. 9A shows an example of a tile of a calibration pattern image;

FIG. 9B shows an example of decoding a pseudo-random dot pattern; and

FIGS. 10A and 10B form a schematic block diagram of a general purpose computer system upon which arrangements described can be practiced.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

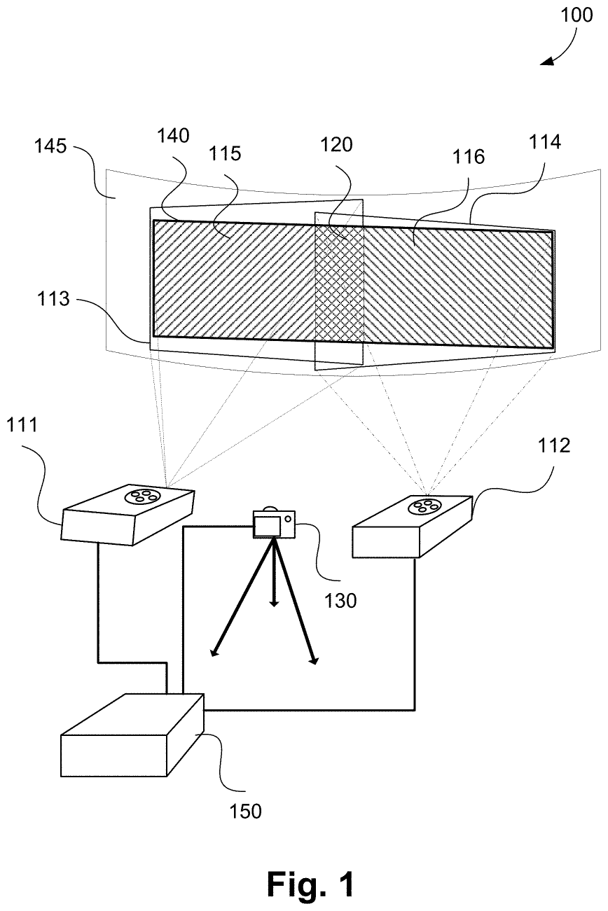

FIG. 1 shows an example of a system 100 for reproducing visual content. The arrangement of FIG. 1 shows a multi-projector system 100. Projectors 111 and 112 project images on to a non-planar projection screen surface 145. However, the arrangements described are equally applicable to calibrating an image capture system comprising multiple image capture devices, or to systems comprising combinations of image capture devices and projectors. The arrangements described relate to alignment of projected images. However, the described arrangements can be extended to relate to alignment for projected video. The projection screen surface 145 is non-planar. For example, the projection screen surface 145 may be cylindrical or spherical in geometry. The projectors 111 and 112 project onto projection areas 113 and 114, respectively.

Projection alignment and overall image rectification may be achieved using methods implemented on a projection controller 1000 of the system 100. The projection controller 1000 obtains a view of a display area 140 on the projection screen surface 145 using a camera 130 and modifies a signal sent to each of the projectors 111 and 112. The first projector 111 projects a first portion 115 of an image and the second projector 112 projects a second portion 116 of the image. The determined first and second portions 115 and 116 are processed such that the projection onto the projection screen surface 145 is rectified with respect to the projection screen surface 145, generating the display area 140. The display area 140 is warped to the geometry of the projection screen surface 145. Further, the determined first and second portions 115 and 116 are processed such that the image content in an overlap area 120 is blended smoothly so that there is no visible discontinuity in the displayed image spatially, in colour or intensity.

The camera 130 may be any image capture device suitable for capturing images of a scene and for transmitting the captured image to the projection controller 1000. In some arrangements the camera 130 may be integral to the projection controller 1000 or one of the projection devices 111 and 112. The projectors 111 and 112 may be any projection devices suitable for projection against a surface such as a wall or a screen. In some arrangements, one of the projectors 111 and 112 may be integral to the projection controller 1000. While the arrangement of FIG. 1 shows two projectors (111 and 112), arrangements that employ different numbers and configurations of projectors and cameras are possible.

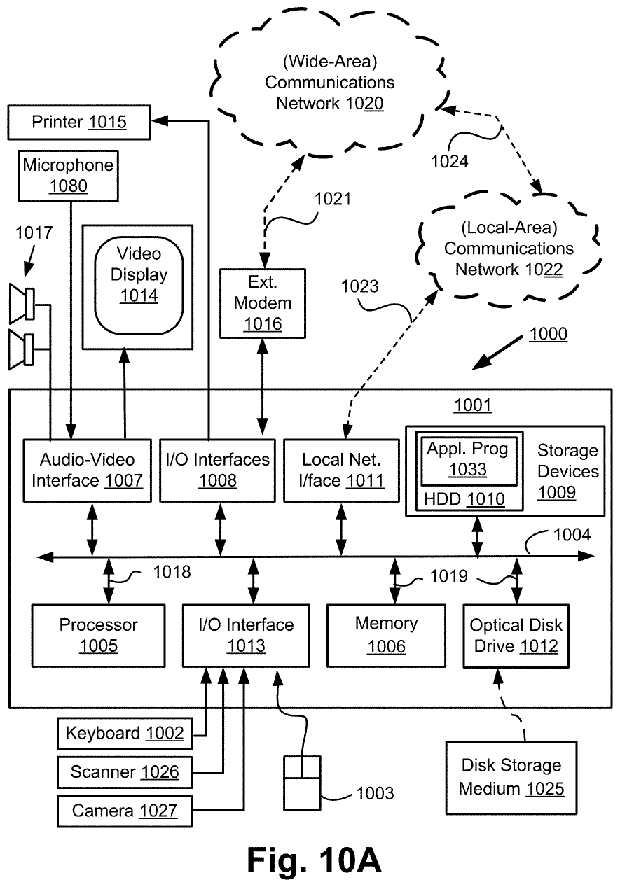

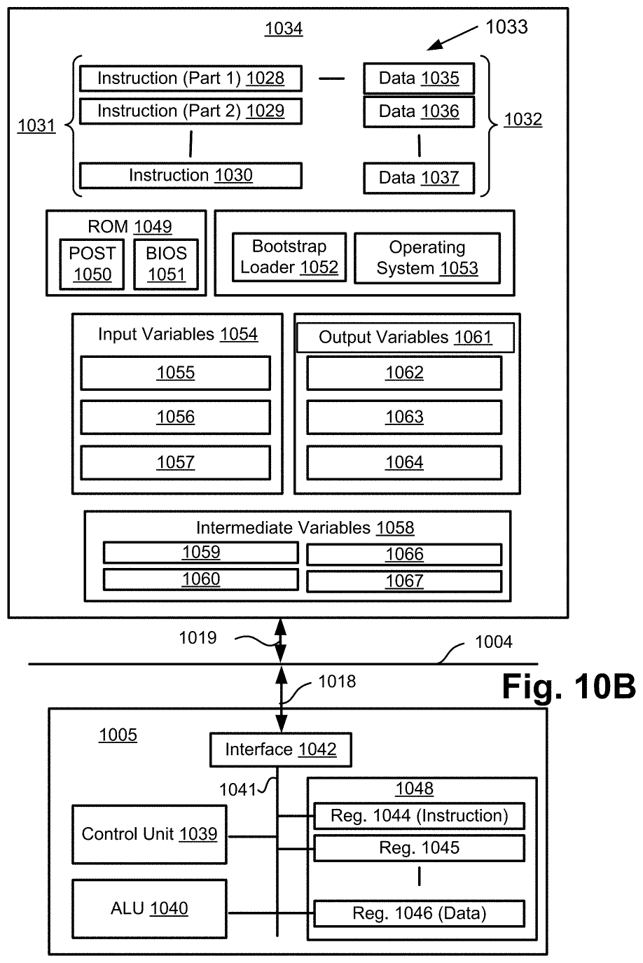

FIGS. 10A and 10B depict a computer system forming the projection controller 1000, upon which the various arrangements described can be practiced.

As seen in FIG. 10A, the projection controller 1000 includes: a computer module 1001; input devices such as a keyboard 1002, a mouse pointer device 1003, a scanner 1026, the camera 130, and a microphone 1080; and output devices including a printer 1015, a display device 1014 and loudspeakers 1017. An external Modulator-Demodulator (Modem) transceiver device 1016 may be used by the computer module 1001 for communicating to and from a communications network 1020 via a connection 1021. The communications network 1020 may be a wide-area network (WAN), such as the Internet, a cellular telecommunications network, or a private WAN. Where the connection 1021 is a telephone line, the modem 1016 may be a traditional “dial-up” modem. Alternatively, where the connection 1021 is a high capacity (e.g., cable) connection, the modem 1016 may be a broadband modem. A wireless modem may also be used for wireless connection to the communications network 1020.

The computer module 1001 typically includes at least one processor unit 1005, and a memory unit 1006. For example, the memory unit 1006 may have semiconductor random access memory (RAM) and semiconductor read only memory (ROM). The computer module 1001 also includes an number of input/output (I/O) interfaces including: an audio-video interface 1007 that couples to the video display 1014, loudspeakers 1017 and microphone 1080; an I/O interface 1013 that couples to the keyboard 1002, mouse 1003, scanner 1026, camera 130 and optionally a joystick or other human interface device (not illustrated); and an interface 1008 for the external modem 1016 and printer 1015. In some implementations, the modem 1016 may be incorporated within the computer module 1001, for example within the interface 1008. The computer module 1001 also has a local network interface 1011, which permits coupling of the computer system 1000 via a connection 1023 to a local-area communications network 1022, known as a Local Area Network (LAN). As illustrated in FIG. 10A, the local communications network 1022 may also couple to the wide network 1020 via a connection 1024, which would typically include a so-called “firewall” device or device of similar functionality. The local network interface 1011 may comprise an Ethernet circuit card, a Bluetooth® wireless arrangement or an IEEE 802.11 wireless arrangement; however, numerous other types of interfaces may be practiced for the interface 1011.

The I/O interfaces 1008 and 1013 may afford either or both of serial and parallel connectivity, the former typically being implemented according to the Universal Serial Bus (USB) standards and having corresponding USB connectors (not illustrated). Storage devices 1009 are provided and typically include a hard disk drive (HDD) 1010. Other storage devices such as a floppy disk drive and a magnetic tape drive (not illustrated) may also be used. An optical disk drive 1012 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the projection controller 1000.

The components 1005 to 1013 of the computer module 1001 typically communicate via an interconnected bus 1004 and in a manner that results in a conventional mode of operation of the computer system 1000 known to those in the relevant art. For example, the processor 1005 is coupled to the system bus 1004 using a connection 1018. Likewise, the memory 1006 and optical disk drive 1012 are coupled to the system bus 1004 by connections 1019. Examples of computers on which the described arrangements can be practiced include IBM-PC's and compatibles, Sun Sparcstations, Apple Mac™ or like computer systems.

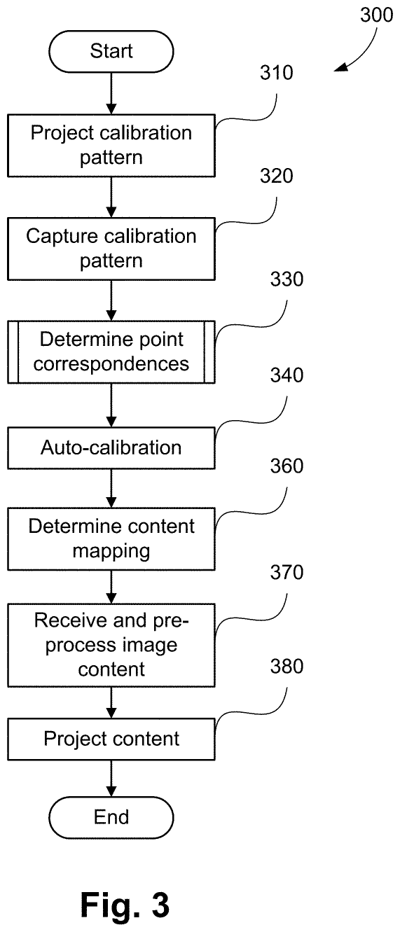

Methods described below may be implemented using the projection controller 1000 wherein the processes of FIGS. 3, 4A, 4B, 5, 6, 7A, 7B, 8, 9A and 9B, to be described, may be implemented as one or more software application programs 1033 executable within the projection controller 1000. In particular, the steps of the described methods are effected by instructions 1031 (see FIG. 10B) in the software 1033 that are carried out within the projection controller 1000. The software instructions 1031 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software 1033 is typically stored in the HDD 1010 or the memory 1006. The software is loaded into the projection controller 1000 from the computer readable medium, and then executed by the projection controller 1000. Thus, for example, the software 1033 may be stored on an optically readable disk storage medium (e.g., CD-ROM) 1025 that is read by the optical disk drive 1012. A computer readable medium having such software or computer program recorded on the computer readable medium is a computer program product. The use of the computer program product in the projection controller 1000 preferably effects an advantageous apparatus for implementing the described methods.

In some instances, the application programs 1033 may be supplied to the user encoded on one or more CD-ROMs 1025 and read via the corresponding drive 1012, or alternatively may be read by the user from the networks 1020 or 1022. Still further, the software can also be loaded into the projection controller 1000 from other computer readable media. Computer readable storage media refers to any non-transitory tangible storage medium that provides recorded instructions and/or data to the projection controller 1000 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1001. Examples of transitory or non-tangible computer readable transmission media that may also participate in the provision of software, application programs, instructions and/or data to the computer module 1001 include radio or infra-red transmission channels as well as a network connection to another computer or networked device, and the Internet or Intranets including e-mail transmissions and information recorded on Websites and the like.

The second part of the application programs 1033 and the corresponding code modules mentioned above may be executed to implement one or more graphical user interfaces (GUIs) to be rendered or otherwise represented upon the display 1014. Through manipulation of typically the keyboard 1002 and the mouse 1003, a user of the projection controller 1000 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1017 and user voice commands input via the microphone 1080.

FIG. 10B is a detailed schematic block diagram of the processor 1005 and a “memory” 1034. The memory 1034 represents a logical aggregation of all the memory modules (including the HDD 1009 and semiconductor memory 1006) that can be accessed by the computer module 1001 in FIG. 10A.

When the computer module 1001 is initially powered up, a power-on self-test (POST) program 1050 executes. The POST program 1050 is typically stored in a ROM 1049 of the semiconductor memory 1006 of FIG. 10A. A hardware device such as the ROM 1049 storing software is sometimes referred to as firmware. The POST program 1050 examines hardware within the computer module 1001 to ensure proper functioning and typically checks the processor 1005, the memory 1034 (1009, 1006), and a basic input-output systems software (BIOS) module 1051, also typically stored in the ROM 1049, for correct operation. Once the POST program 1050 has run successfully, the BIOS 1051 activates the hard disk drive 1010 of FIG. 10A. Activation of the hard disk drive 1010 causes a bootstrap loader program 1052 that is resident on the hard disk drive 1010 to execute via the processor 1005. This loads an operating system 1053 into the RAM memory 1006, upon which the operating system 1053 commences operation. The operating system 1053 is a system level application, executable by the processor 1005, to fulfill various high level functions, including processor management, memory management, device management, storage management, software application interface, and generic user interface.

The operating system 1053 manages the memory 1034 (1009, 1006) to ensure that each process or application running on the computer module 1001 has sufficient memory in which to execute without colliding with memory allocated to another process. Furthermore, the different types of memory available in the projection controller 1000 of FIG. 10A must be used properly so that each process can run effectively. Accordingly, the aggregated memory 1034 is not intended to illustrate how particular segments of memory are allocated (unless otherwise stated), but rather to provide a general view of the memory accessible by the computer system 1000 and how such is used.

As shown in FIG. 10B, the processor 1005 includes a number of functional modules including a control unit 1039, an arithmetic logic unit (ALU) 1040, and a local or internal memory 1048, sometimes called a cache memory. The cache memory 1048 typically includes a number of storage registers 1044-1046 in a register section. One or more internal busses 1041 functionally interconnect these functional modules. The processor 1005 typically also has one or more interfaces 1042 for communicating with external devices via the system bus 1004, using a connection 1018. The memory 1034 is coupled to the bus 1004 using a connection 1019.

The application program 1033 includes a sequence of instructions 1031 that may include conditional branch and loop instructions. The program 1033 may also include data 1032 which is used in execution of the program 1033. The instructions 1031 and the data 1032 are stored in memory locations 1028, 1029, 1030 and 1035, 1036, 1037, respectively. Depending upon the relative size of the instructions 1031 and the memory locations 1028-1030, a particular instruction may be stored in a single memory location as depicted by the instruction shown in the memory location 1030. Alternately, an instruction may be segmented into a number of parts each of which is stored in a separate memory location, as depicted by the instruction segments shown in the memory locations 1028 and 1029.

In general, the processor 1005 is given a set of instructions which are executed therein. The processor 1005 waits for a subsequent input, to which the processor 1005 reacts to by executing another set of instructions. Each input may be provided from one or more of a number of sources, including data generated by one or more of the input devices 1002, 1003, data received from an external source across one of the networks 1020, 1002, data retrieved from one of the storage devices 1006, 1009 or data retrieved from a storage medium 1025 inserted into the corresponding reader 1012, all depicted in FIG. 10A. The execution of a set of the instructions may in some cases result in output of data. Execution may also involve storing data or variables to the memory 1034.

The disclosed arrangements use input variables 1054, which are stored in the memory 1034 in corresponding memory locations 1055, 1056, 1057. The disclosed arrangements produce output variables 1061, which are stored in the memory 1034 in corresponding memory locations 1062, 1063, 1064. Intermediate variables 1058 may be stored in memory locations 1059, 1060, 1066 and 1067.

Referring to the processor 1005 of FIG. 10B, the registers 1044, 1045, 1046, the arithmetic logic unit (ALU) 1040, and the control unit 1039 work together to perform sequences of micro-operations needed to perform “fetch, decode, and execute” cycles for every instruction in the instruction set making up the program 1033. Each fetch, decode, and execute cycle comprises:
a fetch operation, which fetches or reads an instruction 1031 from a memory location 1028, 1029, 1030;
a decode operation in which the control unit 1039 determines which instruction has been fetched; and
an execute operation in which the control unit 1039 and/or the ALU 1040 execute the instruction.

Thereafter, a further fetch, decode, and execute cycle for the next instruction may be executed. Similarly, a store cycle may be performed by which the control unit 1039 stores or writes a value to a memory location 1032.

Each step or sub-process in the processes of FIGS. 3, 4A, 4B, 5, 6, 7A, 7B, 8, 9A and 9B is associated with one or more segments of the program 1033 and is performed by the register section 1044, 1045, 1047, the ALU 1040, and the control unit 1039 in the processor 1005 working together to perform the fetch, decode, and execute cycles for every instruction in the instruction set for the noted segments of the program 1033.

The described methods may alternatively be implemented in dedicated hardware such as one or more integrated circuits performing the functions or sub functions of the described methods. Such dedicated hardware may include graphic processors, digital signal processors, or one or more microprocessors and associated memories.

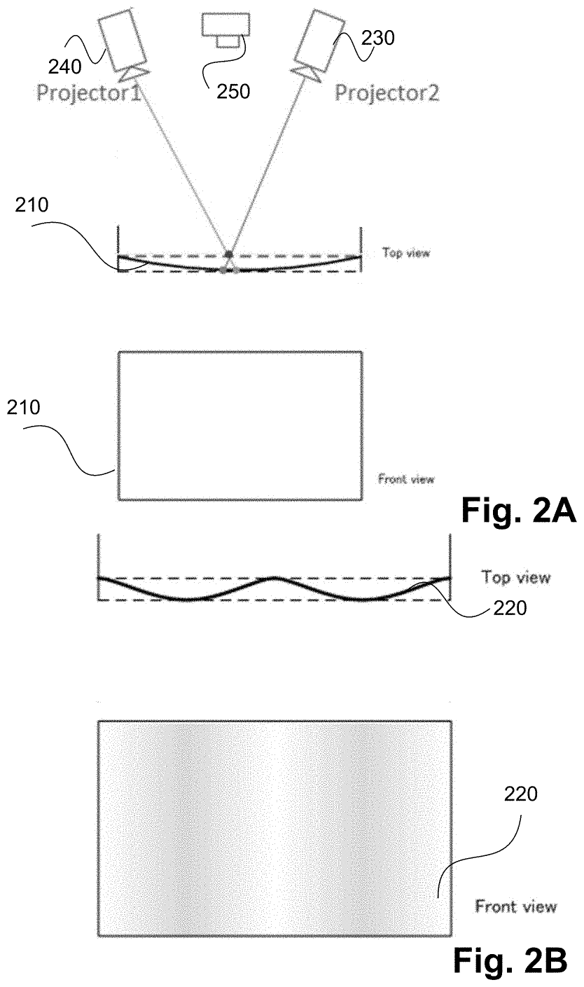

FIG. 2A depicts the top and front views of an example of a simple curved projection surface 210 for the system 100. FIG. 2A shows the projection surface 210 comprising a small concavity in the middle, resulting in a non-planar surface. FIG. 2A also shows projection from projector 111 and projector 112 onto the projection surface 210, and the camera 130 which can capture an image of the projection from the projection surface 210. FIG. 2B shows a slightly more complex example of a curved projection surface 220 that has multiple peaks and troughs along one dimension of the surface. Accurate point correspondences are a prerequisite to achieving projection alignment with high alignment accuracy. The increase in surface complexity (where the non-uniformity in surface or surface gradients are more frequent) usually results in reduced accuracy and stability in estimated point correspondences between the projector and camera image planes. Such reduced accuracy and stability in turn leads to inaccurate calibration and alignment such that the projection portions 115 and 116 are poorly rectified and aligned on the projection screen surface 145.

A method 300 of rendering one or more projector images for reproducing aligned and rectified visual content on the projection screen surface 145 using the multi-projector system 100 is described with reference to FIG. 3.

The method 300 may be implemented as one or more software code modules of the application program 1033 resident on the hard disk drive 1010 and being controlled in its execution by the processor 1005.

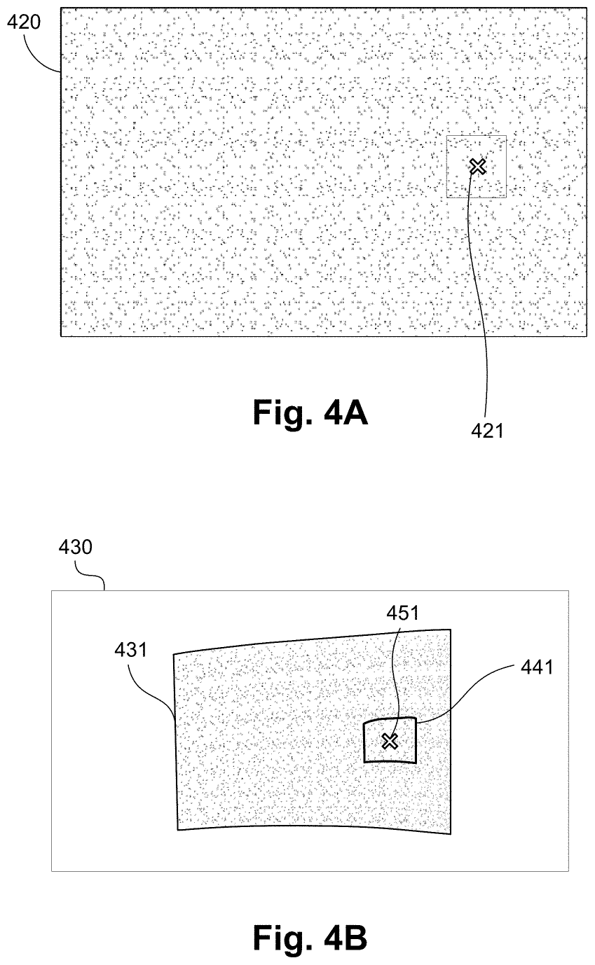

The method 300 starts at a projecting step 310. In execution of the step 310, for each of the projectors 111 and 112 in turn, a structured light calibration pattern such as one comprised of pseudo-random dots as shown in FIG. 4A is projected onto the projection screen surface 145. The method 300 then proceeds to a capturing step 320. In execution of the step 320, for each of the projected calibration patterns by the projectors 111 and 112 in turn, an image 430 of the projected calibration pattern is captured by the camera 130 under execution of the processor 1005 as shown in FIG. 4B. The images captured at step 320 may be stored in the storage module 1009. Camera distortion parameters (for radial and tangential distortion) may be used to determine a corrected camera image 430 that is substantially free of camera lens distortions using any suitable methods such as those methods provided in OpenCV (Open Source Computer Vision). OpenCV is an open source library of programming functions for reducing lens distortion in captured images.

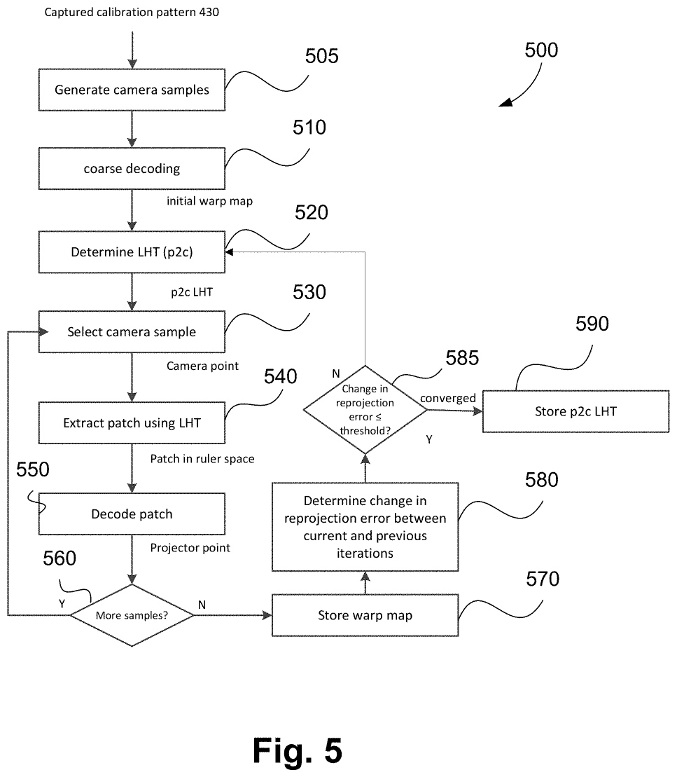

The method 300 then proceeds to a determining step 330 for producing point correspondences between the projectors 111 and 112 and camera image planes. The point correspondences determined at step 330 comprise coordinates 451 of a region 441 of a captured dot pattern 431 in the camera image 430 and corresponding matched position 421 in the projected calibration pattern 420. A method 500 of determining point correspondences between a projector and camera image planes with the calibration pattern 420, as performed at step 330, is described in more detail below with reference to FIG. 5.

After determining step 330, the method 300 continues to an auto-calibration step 340. Step 340 is performed, under execution of the processor 1005, to bring uncalibrated projections from the projectors 111 and 112 into alignment and rectification. Depending on the curvature of the projection screen surface 145, modeling the surface with a normal vector for rectification or a full 3D reconstruction together with estimated projector and camera pinhole models may be performed at step 340.

The projectors 111 and 112 are fully calibrated when there exists, for each projector, a mapping from the projector image to the surface coordinates such that projections from those projectors are aligned with each other and warped to the projection screen surface 145 to produce a single coherent projection.

After the calibrating step 340, the method 300 continues to a determining step 360. A content mapping is determined at determining step 360 under execution of the processor 1005. Content mapping defines the regions from the input images that are to be displayed in each of the projected portions 115, 116, along with blending parameters (such as opacity) to be used in the overlap region (for example region 120 of FIG. 1). In one arrangement, the configuration of the projectors 111 and 112 is determined by the projection controller 1000 and the configuration information is used in the method 300 of content mapping.

Having established the calibration and content mapping parameters, the method 300 continues to a receiving step 370. Image content rectification (regular frame processing) or warping to projection screen surface 145 is performed at step 370 under execution of the processor 1005. At step 370, the input image is received and decoded under execution of the processor 1005. All cropping, interpolation and intensity gradation required to generate the rectified images content to be displayed/projected by each projector is also performed at step 370. The method 300 then continues to project the images at projecting step 380 in each projector 111 and 112.

The method 500 of determining point correspondences between a projector and camera image planes with the calibration pattern 420, as performed at step 330, will now be described in detail with reference to FIG. 5.

The method 500 may be implemented as one or more software code modules of the application program 1033 resident on the hard disk drive 1010 and being controlled in its execution by the processor 1005.

The method 500 commences with the captured calibration pattern 430 as input to a generating step 505. In execution of the step 505, a grid of sample points is generated, under execution of the processor 1005, within the captured calibration pattern 431. A relatively fine grid is used at step 505 so that there is a sufficient number of points within any camera local region that corresponds to a locally flat region of the projection screen surface 145. The grid is spaced such that there is a minimal change in surface gradient between any two adjacent grid nodes. Generally, the more complex the projection surface 220 the more sample points are required. The projection surface 220 requires more sample points to model than the projection surface 210. The grid of sample points generated at step 505 may be stored in the storage module 1009.

After generating a set of camera samples at the generating step 505, the method 500 continues to a decoding step 510. In execution of the step 510, a coarse decoding of the captured calibration pattern 430 is performed, under execution of the processor 1005, to generate an initial warp map. The coarse decoding process (i.e., one which has low or no sub-pixel accuracy) may be achieved using a number of different methods. For example, a Gray code calibration pattern requires a sequence of frames to be projected and captured. Each frame in the sequence of frames encodes a specific bit within each position of the projected image. The bits are merged over the sequence of frames, resulting in absolute positions in the projected image.

Alternatively, a coarse alignment of the captured calibration pattern 431 to the reference calibration pattern 420 based on an affine or perspective transform may be derived using corresponding features of the calibration pattern 420. A coarsely aligned image may then be formed by applying the derived transform to the captured image 430 to form a coarsely aligned image from which regular decoding may be performed. Alternatively, unique markers may be added to the calibration pattern 420 and detected in the captured image 430 to form the initial warp map at step 510. In another alternative, multiple slightly shifted calibration patterns may be projected at step 510 to estimate the initial warp map. The initial warp map determined at step 510 may be stored in the storage module 1009.

After obtaining the initial warp map at the decoding step 510, the method 500 continues to a determining step 520. In execution of the step 520, a local homography transform (LHT) for mapping points between the image planes of the projector 111 or 112 and the camera 130 is determined under execution of the processor 1005. The local homography transform (LHT) is a mapping function between a source and a destination image such that a point in the source image src(x,y) is mapped via the LHT to a point in the destination image dst(i,j) and vice versa, in accordance with Equation (1), below:

dst(i,j)=LHT(src(x,y))

src(x,y)=LHT⁻¹(dst(i,j) (1)

The local homography transform (LHT) may be used to model correspondence mapping between the projector and camera image planes induced by a non-planar surface such as surfaces 210 and 220. The projection screen surface 145 is assumed to be a piecewise planar surface, consisting of localized flat regions, when using the LHT. That is, the projection surface can be considered to have formed by joining a number of flat surfaces together.

For a planar surface, a homography defines a transformation between points on two 2-dimensional planes (e.g. image planes of the projector 111 and the camera 112). The homography is said to be induced by the said planar surface. Therefore, a camera-projector homography (H_{cp}) is represented as a 3×3 matrix in accordance with Equation (2), as follows:

$$s [ \begin{matrix}{x}_{p} \\ {y}_{p} \\ 1\end{matrix} ] ∼ {H}_{cp} [ \begin{matrix}{x}_{c} \\ {y}_{c} \\ 1\end{matrix} ] \qquad ( 2 )$$

In the case of a slightly curved projection surface such as 210 and 220, the assumption that the projection screen surface 145 is a piecewise planar surface allows the surface to be modeled using multiple homographies, such that each locally flat region is represented by its own homography.

Given that a homography is fitted using points in a source image and corresponding points in a destination image, then a local homography region thus defines a quadrilateral (quad) in the source image, a quadrilateral in the destination image, and a homography that maps points in the source quad to points in the destination quad. Mappings for points outside the local homography region are thus undefined.

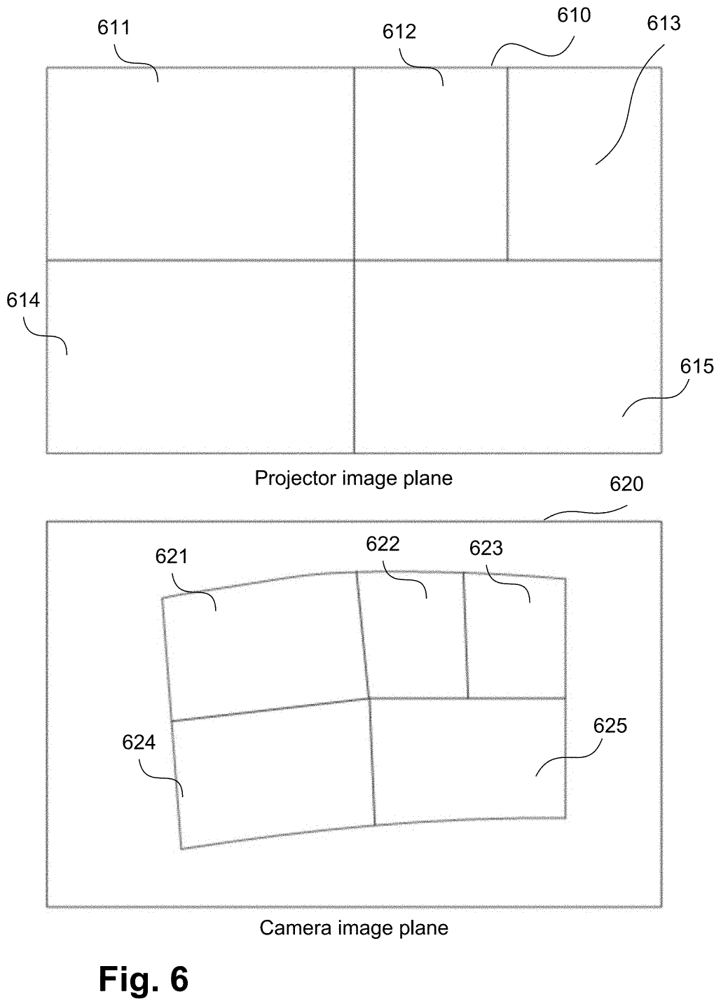

FIGS. 6A and 6B show an example of local homography regions in the projector and camera image planes, respectively. In the example of FIGS. 6A and 6B, the projector image plane 610 is the source image and the camera image plane 620 is the destination image. Local projector regions 611, 612, 613, 614 and 615 correspond to local camera regions 621, 622, 623, 624 and 625, respectively. For each pair of corresponding projector and camera local regions, there is a homography that maps points inside the projector local region to a corresponding camera local region, and vice versa.

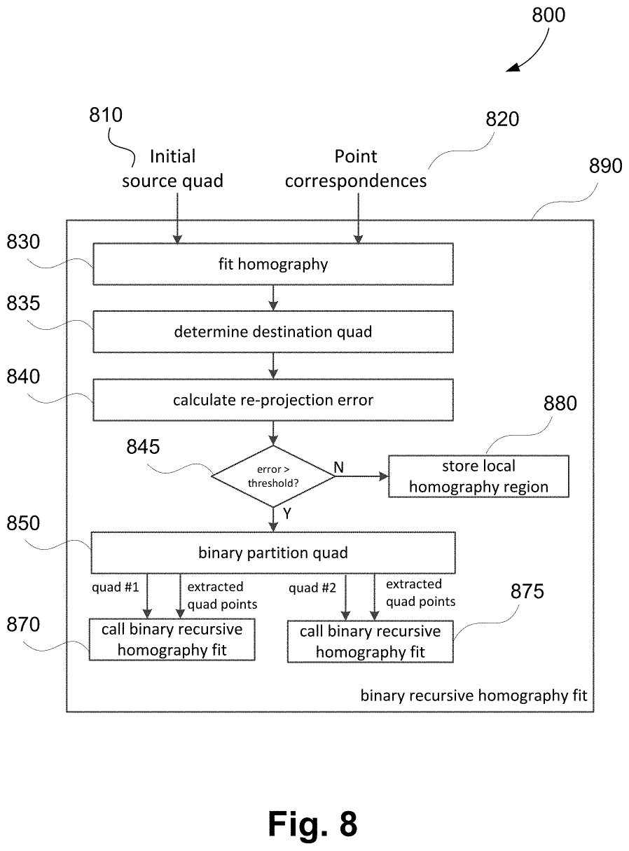

A method 800 of determining a local homography transform (LHT) between the projector image plane 610 and camera image plane 620 with a camera-projector warp map obtained from step 510 (initial warp map) or 585 (refined warp map), as performed at step 520, is described in more detail below with reference to FIG. 8.

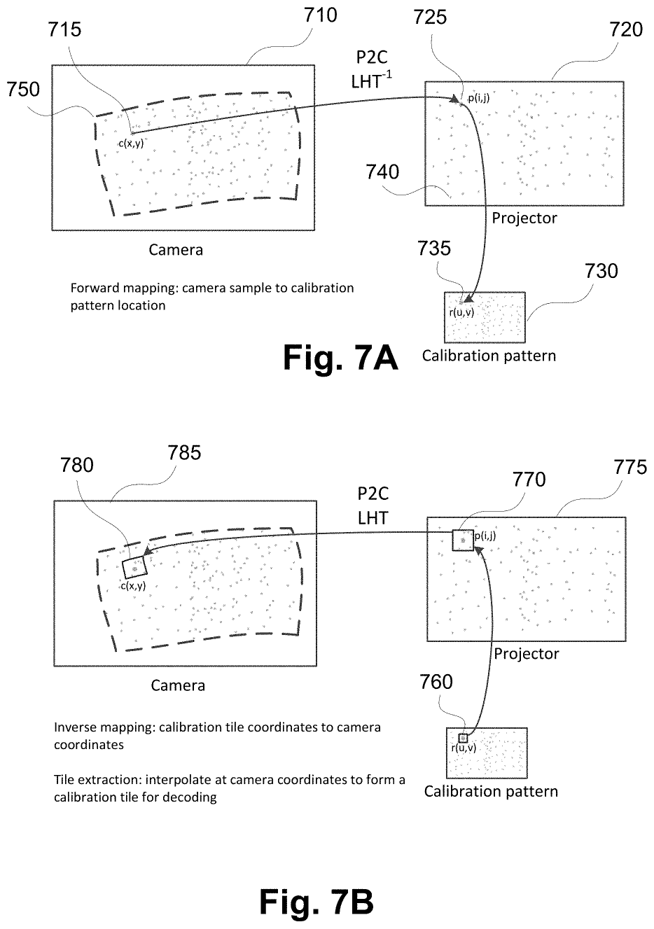

After the determining step 520, the method 500 continues to a selecting step 530. In execution of the step 530, a new (previously unselected) camera sample is selected from the grid of sample points generated in the step 505, under execution of the processor 1005, for further processing. The method 500 then continues to an extracting step 540, in which a neighbourhood of pixels surrounding the camera sample from the step 530 is extracted and unwarped to a patch in the calibration pattern space. A patch is a two dimensional (2D) array of image pixels. The extracting step 540 will be further described with reference to FIGS. 7A and 7B. FIG. 7A shows a forward mapping that allows each camera sample c(x,y) 715 inside a captured calibration pattern 750 to be mapped to a corresponding calibration pattern coordinate r(u,v) 735. FIG. 7B shows an inverse mapping that allows a neighbourhood 780 of camera pixels centered at camera sample c(x,y) 715 to be extracted and unwarped to a patch (or tile) in calibration pattern space with the same dimension as a reference calibration patch 760.

As seen in FIG. 7A, an approximate projector point p(i,j) 725 in structured light calibration pattern 740 in the projector image plane 720 may be determined by applying an inverse projector-to-camera local homography transform (p2c LHT⁻¹) to camera sample point c(x,y) 715 as selected at the step 530. The projector point p(i,j) 725 is further mapped to a corresponding calibration coordinate r(u,v) 735 of an original calibration pattern 730. Typically, the original calibration pattern 730 and the projector image plane 720 are not equal in size, so that the calibration pattern 730 needs to be scaled to fit in the projector image plane 720. If, however, the calibration pattern 730 and the projector image plane 720 are the same size then there is a one-to-one correspondence between the calibration pattern 730 and the projector image plane 720, and 735 r(u,v) is the same as 725 p(i,j).

As described above, FIG. 7A shows a forward mapping that allows each camera sample c(x,y) 715 inside the captured calibration pattern 750 to be mapped to corresponding calibration pattern coordinate r(u,v) 735. The accuracy of the forward mapping from c(x,y) to r(u,v) depends entirely on accuracy of the camera-projector LHT, which in turn is dependent on the accuracy of the input camera-projector warp map. At the beginning of the method 500, the very first camera-projector LHT is based on the coarse warp map derived at the step 510, which means the accuracy of the mapping from c(x,y) to r(u,v) is low as well.

As described above, FIG. 7B shows an inverse mapping that allows a neighbourhood 780 of camera pixels centered at the camera sample c(x,y) 715 to be extracted and unwarped to a patch (or tile) in calibration pattern space with the same dimension as a reference calibration patch 760. As seen in FIG. 7B, region 770 is a region in the projector image plane that corresponds to the extracted and unwarped patch. The extracted and unwarped patch is not shown in FIG. 7B. Consider region 760 as an original patch, which is scaled to projector image space as patch 770. When the original patch 760 is projected (thus becoming patch 770) and captured by the camera 130, the patch 760 becomes patch 780, thus becoming warped. Thus, a patch within the calibration pattern corresponding to the warped patch 780, is the extracted and unwarped patch, which would be very similar to patch 760, except for additional noise and distortion. The extracted and unwarped patch is supposed to be the corresponding patch of the reference patch 760, and by decoding the extracted and unwarped patch, location coordinates (u,v) in the ruler space are determined.

The inverse mapping of FIG. 7B maps calibration tile coordinates to camera coordinates. The inverse mapping starts from the calibration pattern coordinate r(u,v) 735. A set of calibration pattern coordinates corresponding to pixel locations of the reference calibration patch 760 or tile centered at r(u,v) 735 is determined. In one arrangement, the reference calibration patch is forty-nine (49) by forty-nine (49) pixels in size.

The forty-nine (49)×forty-nine (49) calibration pattern coordinates are then mapped to projector image plane 775 forming a set of forty-nine (49) by forty-nine (49) projector plane coordinates corresponding a region 770 centered at the projector location p(i,j) 725. The set of forty-nine (49) by forty-nine (49) projector plane coordinates are further mapped to the camera image plane 785 with the projector-camera LHT to form a set of forty-nine (49) by forty-nine (49) camera plane coordinates corresponding region 780 centered at the camera location c(x,y) 715. The region 780 is extracted and unwarped using interpolation to calibration pattern space into a calibration patch ready for decoding. A high quality interpolation method may be used in unwarping region 780 to preserve feature integrity of the calibration patch as well as reduce interpolation artefacts. In one arrangement, a Lanczos interpolation method may be used in unwarping region 780.

After extracting a calibration patch at step 540, the method 500 continues to a decoding step 550. In execution of the step 550, the extracted calibration patch is decoded, under execution of the processor 1005, to identify the corresponding encoded position in the calibration pattern 730.

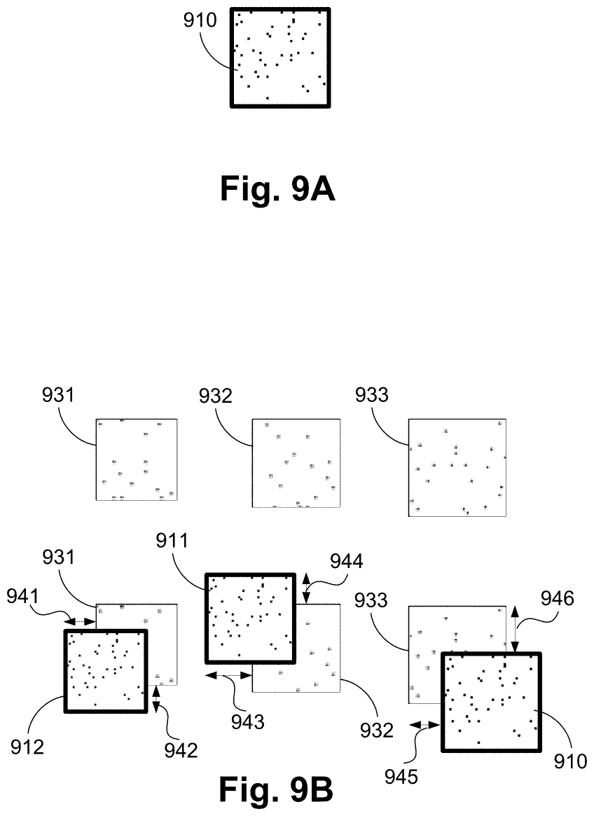

An example of decoding a pseudo-random dot pattern at a position within a captured calibration pattern image, using direct correlation, will now be described with reference to FIG. 9A. A tile of a captured calibration pattern image is firstly extracted. For example, tile 910 may be the extracted and unwarped patch corresponding to portion 780 within the captured calibration pattern image 710.

The extracted tile 910 is then correlated with the projected calibration pattern 730 using any suitable method. For example, a Discrete Fourier Transform (DFT) of both the extracted tile 910 and the calibration pattern 730 may be determined. The spectra produced by the DFT are then multiplied, and the result of the multiplication is transformed back to the spatial domain using inverse DFT (iDFT). The iDFT produces an image that contains many peaks, where the largest peak corresponds to the location (offset, shift) of the extracted tile within the calibration pattern that has the highest correlation (i.e. a match).

An alternative method of forming and decoding a pseudo-random dot calibration pattern will be described in detail below with reference to FIG. 9B. The calibration pattern 730 may be formed by tiling two or more smaller tiles of pseudo-random dots, throughout the calibration pattern to form a 2D ruler. For example, calibration pattern 730 may be formed by tiling three smaller reference tiles 931-933. To determine the position of an extracted tile within the calibration pattern 730, extracted tile 910 is correlated with each of the tiles 931, 932 and 933, to determine an offset (shift) for each tile. Any known method of correlation may be used to determine the position of an extracted tile 910 within the calibration pattern 730. For example, the DFT-based method described above with respect to FIG. 9A may be used to determine the position of an extracted tile 910 within the calibration pattern 730. The separate tile shifts are then combined, to determine the absolute position of the extracted tile 910 within the calibration pattern 730. One method of combining separate tile offsets (shifts) to form an absolute positon is the Chinese Remainder Theorem (CRT).

The correlation of the extracted tile 910 with each of the three reference tiles 931-933 used to form the calibration pattern 730 will now be described with reference to FIG. 9B. The correlation with each tile determines the x- and y-offset of the extracted tile 910 that results in a match. In one arrangement, the sizes of the three reference tiles are 41×41, 45×45 and 49×49 for the tiles 931, 932 and 933, respectively. Because the reference tiles are different in size, the extracted tile 910 is cropped to the corresponding reference tile size before a correlation can be performed. For example, the correlation of a cropped tile 912 of the extracted tile 910 with the first reference tile 931 results in an x-offset 941 and a y-offset 942; the correlation of a cropped tile 911 of the extracted tile 910 with the second reference tile 932 results in an x-offset 943 and a y-offset 944; and the correlation of the extracted tile 910 with the third reference tile 933 results in an x-offset 945 and a y-offset 946. The three sets of x and y offsets are then combined to determine the absolute position of the extracted tile 910 within the calibration pattern 730 using the Chinese Remainder Theorem (CRT).

After decoding the extracted patch 910, the method 500 continues to a decision step 560. At the step 560, a check is performed to determine if there are more camera samples to be processed. The method 500 returns to the selecting step 530 if there are remaining camera samples to be processed, otherwise processing of the method 500 moves to a storing step 570. At the step 570, the newly decoded warp map is stored for future use. The newly decoded warp map may be stored for example within the storage module 1009.

After storing the warp map at the step 570, the method 500 proceeds to a determining step 580. In execution of the step 580, a change in re-projection error between the current iteration Et at time (t) and iteration Et-1 at previous time (t-1) is determined in accordance with Equation (3), as follows:

ΔE=abs(Eₜ−Eₜ₋₁) (3)

Specifically, the re-projection error is determined between the newly created warp map and the current projector-camera LHT mapping function such that the total re-projection error for iteration t may be determined in accordance with Equation (4), as follows:

$${E}_{t} = {\sum }_{k}^{n} d ( {p}_{k} , {\hat{p}}_{k} )$$

where

pₖ=p2c_LHT⁻¹(cₖ) (4)

is a projector point pₖ mapped from a camera point cₖ via the inverse of the local homography transform p2c_LHT, and

warp map:{cₖ↔\hat{p}ₖ}

such that \hat{p}ₖ is a point in the projector image plane mapped from a camera point cₖ using the warp map.

After the determining step 580, the method 500 continues to a decision step 585. At the step 585, a check is performed to determine if the change in re-projection error is less than or equal to a pre-defined threshold. The method 500 returns to the determining step 520 if the change in re-projection is greater than the threshold, otherwise processing of the method 500 moves to a storing step 590. In one arrangement, the pre-defined threshold is one (1) projector pixel.

At the storing step 590, the current p2c LHT is stored as a final mapping function between the image planes of the projector and the camera. The current p2c LHT may be stored in the storage module 1009 under execution of the processor 1005.

The iterative loop between 585 and 520 in the method 500 has the effect of refining the local homography transform with more accurate mapping as well as improving the decoding accuracy of the warp map simultaneously. The local homography transform is refined since the 2D ruler pattern that the decoding accuracy increases with improved unwarping of the decoding tile.

The method 800 of determining a local homography transform (LHT), as performed at step 520 of FIG. 5, will now be described in detail with reference to FIG. 8. The local homography transform exists between point correspondences (warp map) 820 of the image planes of the projector and camera induced by the projection screen surface 145. In addition to having the warp map 820, there needs to be an initial source region 810 for sub-division into smaller local planar regions. In the example of FIG. 6, the projector plane is selected as the source image and borders of the projector plane correspond to the source region (or quad) 810 because the initial quad is rectangular for sub-division. The LHT is a set of corresponding local regions between the source and destination images such that each pair of corresponding local regions may be accurately modeled using a single homography with low re-projection error.

The method 800 begins with the initial source quad 810 and the warp map 820 in a fitting step 830. In execution of the step 830, a homography transform is determined, under execution of the processor 1005, using the image points in the warp map 820. The method 800 then proceeds to a determining step 835, where the corresponding destination quad is determined, under execution of the processor 1005, based on the fitted homography and the source quad 810. The method 800 then continues to a calculating step 840, where a mean re-projection error between the fitted homography and the warp map 820 is determined under execution of the processor 1005. Re-projection error is a measure of surface flatness such that a low mean re-projection error corresponds to a high surface flatness.

After calculating the mean re-projection error, the method 800 continues at a decision step 845. In execution of the step 845, a check is performed to determine if the mean re-projection error is greater than a pre-defined error threshold. The method 800 proceeds to a storing step 880 if the mean re-projection error is not greater than the pre-defined error threshold; otherwise the method 800 continues to a binary partitioning step 850. In one arrangement, the pre-defined error threshold is 0.5 projector pixels. In execution of the step 880, a pair of corresponding local regions in the source and destination image is identified as having an accurate mapping via a homography. Collectively, the source and destination quads, the homography of the source and destination quads and the re-projection error of the local region may be referred to as a local homography region. That is, a local homography region has the following properties:
a source quad;
a destination quad;
a homography transform; and
a re-projection error

If the current pair of corresponding local regions in the source and destination image has a re-projection error greater than the threshold, then mapping between those local regions cannot be adequately modeled by a single homography. The source region needs to be partitioned into smaller quads, so that eventually all local regions may be modeled using a homography.

The method 800 continues to binary partitioning step 850. In execution of the step 850, the source quad 810 is sub-divided or partitioned into two arrangements. In a first arrangement of the source quad 810, the source quad 810 is partitioned along the x-axis in the middle, resulting in two equal size quads on the left and on the right of the source quad 810. In a second arrangement of the source quad 810, the source quad 810 is partitioned along the y-axis in the middle, resulting in two equal size quads on the top and bottom halves of the source quad 810. For each partition, a subset of the warp map points within the partition is extracted. The extracted point correspondences are used to fit a homography, and to determine resulting re-projection error of the fitted homography. Thus, each arrangement has two re-projection errors. The arrangement with the lowest total re-projection error from the two partitions of the corresponding arrangement is selected as a preferred partition arrangement.

After partitioning the source quad 810 into the selected arrangement at the step 850, the method 800 continues with the two quads from the selected arrangement to two calling steps 870 and 875, respectively. In execution of the step 870, the first sub-quad and corresponding subset of warp map points are used as inputs to calling the binary recursive homography fit step 890. Similarly, in execution of the step 875, the second sub-quad and corresponding subset of warp map points are used as inputs to calling the binary recursive homography fit step 890. Together, steps 870 and 875 has the effect of recursively sub-dividing the initial source quad 810 into a number of local homography regions that all have a re-projection error below the predefined threshold, thereby ensuring each local homography region of a curved surface such as surface 220 has a high degree of flatness.

The arrangements described are applicable to the computer and data processing industries and particularly for image processing.

The foregoing describes only some embodiments of the present invention, and modifications and/or changes can be made thereto without departing from the scope and spirit of the invention, the embodiments being illustrative and not restrictive.

1. A method of generating an improved warp map for a projection on a non-planar surface, the method comprising:
receiving an initial warp map of the projection on the non-planar surface captured by a camera, the projection being formed on the non-planar surface using a projector and the initial warp map;
generating a plurality of regions on the non-planar surface, each of the plurality of regions having a size and location determined from a measure of flatness for the region based on the initial warp map;
determining an unwarped image of a calibration pattern projected on the non-planar surface by applying an inverse transform to each of the plurality of regions on the non-planar surface, each transform mapping pixels of the projection to pixels of the camera according to the initial warp map; and
determining a plurality of locations in the determined unwarped image of the calibration pattern to generate the improved warp map.

2. The method according to claim 1, further comprising applying correlation to the determined unwarped image to improve accuracy of the determined locations.

3. The method according to claim 1, wherein a tile of the captured calibration pattern is correlated with the reference calibration pattern tiles.

4. The method according to claim 1, wherein the initial warp map represents a mapping between image coordinates of the projector and camera.

5. The method according to claim 4, further comprising projecting a structured light calibration pattern onto the non-planar surface.

6. The method according to claim 1, further comprising producing point correspondences between image planes of the projector and the camera.

7. The method according to claim 1, further comprising determining a content mapping.

8. The method according to claim 1, further comprising performing a coarse decoding to the calibration pattern.

9. The method according to claim 1, wherein the inverse transform is a local homography transform.

10. The method according to claim 9, further comprising determining a mean re-projection error using the local homography transform.

11. The method according to claim 9, wherein the local homography transform is based on a local homography region.

12. A system for generating an improved warp map for a projection on a non-planar surface, the system comprising:
a memory for storing data and a computer program;
a processor coupled to the memory for executing the computer program, the program having instructions for:
receiving an initial warp map of the projection on the non-planar surface captured by a camera, the projection being formed on the non-planar surface using a projector and the initial warp map;
generating a plurality of regions on the non-planar surface, each of the plurality of regions having a size and location determined from a measure of flatness for the region based on the initial warp map;
determining an unwarped image of a calibration pattern projected on the non-planar surface by applying an inverse transform to each of the plurality of regions on the non-planar surface, each transform mapping pixels of the projection to pixels of the camera according to the initial warp map; and
determining a plurality of locations in the determined unwarped image of the calibration pattern to generate the improved warp map.

13. An apparatus for generating an improved warp map for a projection on a non-planar surface, the apparatus comprising:
means for receiving an initial warp map of the projection on the non-planar surface captured by a camera, the projection being formed on the non-planar surface using a projector and the initial warp map;
means for generating a plurality of regions on the non-planar surface, each of the plurality of regions having a size and location determined from a measure of flatness for the region based on the initial warp map;
means for determining an unwarped image of a calibration pattern projected on the non-planar surface by applying an inverse transform to each of the plurality of regions on the non-planar surface, each transform mapping pixels of the projection to pixels of the camera according to the initial warp map; and
means for determining a plurality of locations in the determined unwarped image of the calibration pattern to generate the improved warp map.

14. A non-transitory computer readable medium having a program stored on the medium for generating an improved warp map for a projection on a non-planar surface, the program comprising:
code for receiving an initial warp map of the projection on the non-planar surface captured by a camera, the projection being formed on the non-planar surface using a projector and the initial warp map;
code for generating a plurality of regions on the non-planar surface, each of the plurality of regions having a size and location determined from a measure of flatness for the region based on the initial warp map;
code for determining an unwarped image of a calibration pattern projected on the non-planar surface by applying an inverse transform to each of the plurality of regions on the non-planar surface, each transform mapping pixels of the projection to pixels of the camera according to the initial warp map; and
code for determining a plurality of locations in the determined unwarped image of the calibration pattern to generate the improved warp map.
